(19) United States
(12) Patent Application Publication
(10) Pub. No.: US 2019/0329198 A1
(43) Pub. Date: Oct. 31, 2019

(54) DEVICE AND METHOD FOR MIXING, IN PARTICULAR DISPERSING

(71) Applicant: BÜHLER AG, Uzwil (CH)

(72) Inventors: Achim Philipp STURM, Niederuzwil (CH); Eduard NATER, Zuckenriet (CH)

(21) Appl. No.: 16/074,231

(22) PCT Filed: Jan. 31, 2017
(86) PCT No.: PCT/EP2017/051965

§ 371 Date: Jul. 31, 2018

(30) Foreign Application Priority Data
Feb. 17, 2016 (EP) 16156047.9

(51) Int. Cl. B01F 15/02; B01F 5/10

(52) U.S. Cl. CPC B01F 15/02; B01F 7/28; B01F 5/10

(57) ABSTRACT

A device (1) for mixing, in particular dispersing, includes a housing (2) with at least one inlet (3) and a grinding chamber (13). In addition, the grinding chamber (13) includes a first process region (4) for mixing fed materials, wherein the materials are introducible into the first process region (4) through the at least one inlet (3), and a second process region (5) for diverting the mixture to an outlet (6) as well as a separating device (7) for separating the first process region from the second process region, and a rotor (8) for mixing, in particular dispersing the mixture in the first process region (4), wherein the rotor is drivable by a drive shaft (9). A pump (10) connected upstream is drivable by the drive shaft (9) and materials are feedable by means of the pump (10) into the first process region (4) and the first process region comprises a dispersion volume within the range of 11-501, in a preferred manner of 41-121 and particularly preferred is 61.

The present invention relates to a device and to a method for mixing, in particular dispersing according to the preamble of the independent claims.

In practice, for example in the paint industry, a predefined amount of liquid is frequently pre-mixed with a predefined amount of a powdery solid, as a rule pigment. These types of mixtures are then ground further, where necessary, in agitator bead mills and dispersed. The production of paints and lacquers or similar is an example of industrial application.

In a conventional mixing process, the average pigment size is certainly dispersed into the necessary range, but oversize material, which is unwanted, remains.

The term mixing in the present case is to be understood as combining materials or material flows in such a manner that as uniform a composition as possible is achieved; within the framework of the invention, the mixing serves, in particular, for producing dispersions, that is to say for dispersing. The term dispersion, in this connection, is to be understood as a heterogenous mixture produced from at least two materials which do not dissolve into one another or bond chemically with one another or only partially dissolve into one another or bond chemically with one another. During the operation of dispersing, a material (dispersed phase) is distributed as finely as possible into another material (dispersing agent or continuous phase), where applicable by using grinding aids; ball-shaped grinding aids are frequently used, for example in agitator bead mills. The present invention relates above all to the production of suspensions, that is to say dispersions where a liquid forms the continuous phase and a solid material forms the dispersed phase. Typically, the crushing can be the dissolving of agglomerate primary particles. Aggregates can also be crushed into primary particles, however, during dispersing. In addition, agglomerates can be dispersed into smaller agglomerates. Whereas the dissolving of agglomerates can also occur in devices without grinding aids as in a disperser or dissolver, devices with grinding aids are required, such as, for example, a grinding mill with ball-shaped grinding aids, to crush aggregates or crystal. Aggregates in the broader sense can also be understood, in this connection, as larger crystalline or amorphous structures. Where aggregates, crystalline or amorphous structures are crushed, true grinding is referred to.

Generic devices for mixing two materials, in particular a liquid and a solid, such as, for example, a powder, normally comprise a housing and a rotor which rotates therein. The materials are introduced into the housing by means of at least one feed line. During an operation of the device, the materials are mixed by means of the rotor and are then conducted out of the housing.

A device for dispersing as well as an associated method are described in U.S. Pat. No. 6,029,853. The device for dispersing includes a chamber for dispersing, at least one agitating disc, an inlet through which the liquid with the material to be treated and the dispersion medium are sucked-in as a result of rotating the agitating disc, an outlet and a separating device. The separating device is arranged at the outlet. The grinding aids are separated from the dispersion by means of the separating device.

DE 10 2010 053 484 discloses an agitator bead mill with a separating device for grinding aids, the separating device being arranged about a rotational axis. The separating device consists of two components, one component is at least one separating device and a second component is a dynamic element for generating a material flow. The device includes a very small dynamic gap as a separating device such that the output is reduced.

It is, consequently, the object of the present invention to avoid the disadvantages of the prior art and, in particular, to create a device and a method for mixing and dispersing which enables a high throughput of material and at the same time the reduction of oversize material.

The object is achieved by a device and a method for mixing according to the characteristic part of the independent claims.

The object is achieved, in particular, by a device for mixing, in particular dispersing, which device includes a housing with at least one inlet and a grinding chamber. The grinding chamber includes a first process region for mixing fed materials, wherein the materials are introducible into the first process region through the at least one inlet. The grinding chamber additionally includes a second process region for diverting the mixture to an outlet. The device further includes a separating device for separating the first process region from the second process region, and a rotor for mixing, in particular dispersing the mixture in a first process region, wherein the rotor is drivable by a drive shaft.

A pump connected upstream is drivable by the drive shaft and materials are feedable by means of the pump into the first process region.

The pump preferably comprises a separate pump chamber, which is arranged upstream with respect to the first process region.

A pump rotor may be arranged rotatable within the pump chamber. The pump rotor may be fixed to the drive shaft, such that it is rotated with the shaft.

During the process there are no grinding aids within the pump chamber. The pump only drives the mixture which is to be mixed and/or dispersed.

The pump chamber may be arranged separately in a pump housing or the pump chamber is integrated into the housing which comprises the grinding chamber.

The pump chamber may comprise and inlet and an outlet, wherein the outlet is in fluid communication with an inlet of the first process region.

The first process region comprises a dispersion volume within the range of between 1 and 50 litres, in a preferred manner between 4 and 12 litres and particularly preferred is 6 litres. A device of this type enables a comparatively large throughput per dispersion volume and is consequently suitable, in particular, as a pre-dispersion stage.

The dispersion volume is formed by the first process region into which dispersion grinding aids can be introduced. In a preferred manner, the materials are introduced pre-mixed into the inlet of the device.

In addition, only one drive is necessary in order to drive the pump and the rotor in the grinding chamber. Consequently, the device is able to be produced in a cost-efficient manner.

The separating device can be at least one separating gap, in a preferred manner at least one dynamic separating gap.

By using a dynamic separating gap, no material is accumulated between the first and the second process region. Consequently, the risk of a blockage is reduced.

The separating gap can have a dimension of between 0.5 mm and 3 mm, in a preferred manner of between 0.8 mm and 1.5 mm and partitularly preferred of 1 mm.

A separating gap of this type is capable of holding back particles that are larger than the separating gap dimension. In particular, where dispersion grinding aids are used, a separating gap of this type can hold back dispersion grinding aids which are larger than the named specifications.

A recirculation container, in particular with an agitating tool, and/or a recirculation line can be arranged between the outlet and the inlet of the device.

Recirculating an already dispersed mixture results in a reduction in the particle size, in particular with reference to the presence of oversize material.

Oversize material is understood here as the proportion of solid particles which is in excess of the admissible solid unit or in excess of the slot width of the grinding aid separating device of the following fine dispersion device.

Dispersion grinding aids, in particular dispersion grinding aids with a mean diameter of between 1.5 mm and 6 mm, in a preferred manner of 3.0 mm, are pourable into or poured into the first process region.

As a result of dispersion grinding aids in the first process region, optimum dispersion is obtained and as a result of using comparatively large dispersion grinding aids, the oversize material, in particular, is reduced and a high throughput is maintained.

Grinding tools, which are realized for generating dynamic movement in the mixture for dispersing the fed materials, can be realized in the first process region.

These types of grinding tools can be discs or pins or blades which project into the first process region. In this connection, grinding tools can be fastened on the stator and/or on the rotor. The grinding tools generate a movement in the mixture and in particular in the dispersion grinding aids such that optimum dispersion is achieved.

A ratio between main line diameters in front of the inlet and ispersion volumes can be within a range of between 8 and 16 mm/litre.

The main line diameter refers to the line in front of the inlet, in particular between the container collecting the materials and the inlet. In this connection, a narrower line diameter can be present, for example, in the region directly in front of the device in order not to enlarge the device unnecessarily.

A ratio of this type between main line diameter and dispersion volumes leads to the possibility of achieving a high throughput and consequently of conducting as much mixture as possible as quickly as possible through the device.

The outlet can be connectable to or connected to an inlet of a fine grinding stage.

Consequently, the device is utilized as a pre-dispersion stage and, in this connection, can reduce, in particular, the oversize material. The additional reduction of the mean particle size can then be carried out in a following fine grinding stage. Consequently, optimum dispersion of the particles is achieved and at the same time high throughput is ensured.

In addition, the object is achieved by a method for mixing, in particular dispersing, in a preferred manner in a device as described beforehand, said method including the following steps:
introducing, in particular pumping, at least two materials, in particular a solid and a liquid, into a grinding chamber of a device, wherein the grinding chamber comprises two process regions,
mixing the materials, in particular dispersing the materials, in a first process region of the grinding chamber, in particular by means of dispersion grinding aids, wherein the first process region comprises a dispersion volume,
conducting the mixture through a separating device, in particular for separating off dispersion grinding aids, into a second process region,
conducting the mixture through an outlet, wherein a through-put of mixture volume per time is conducted through the outlet,
wherein the ratio of throughput to dispersion volume is greater than 650 1/(h*1), in a preferred manner is within a range of between 650 1/(h*1) and 10,000 1/(h*1) and particularly preferred is 2000 1/(h*1).

Such a method enables a high throughput with a small dispersion volume and consequently leads to rapid dispersion and a reduction in oversized material.

The mixture can be recirculated at least in part or at times from the outlet back to the inlet, in particular via a recirculation container, in a preferred manner with an agitating tool, and/or a recirculation line.

Consequently, optimum dispersion is ensured. A collecting container, in this connection, can be arranged between the outlet and the inlet. Depending on the application, the method can be used in continuous mode or in batch production mode.

The mixture can be conducted at least in part or at times from the outlet to an inlet of a fine dispersion stage.

Consequently, the oversize material is first of all reduced and in the fine dispersion stage, as already known from the prior art, the mean particle size is reduced to the desired range.

In the fine dispersion stage, the dispersion can be further dispersed by means of fine grinding aids, wherein the fine grinding aids comprise a smaller mean diameter than the dispersion grinding aids. The diameters of the fine grinding aids can be within the range of between 0.03 mm and 2.0 mm, in particular between 0.05 mm and 1.5 mm.

Consequently, at the end of the process optimum dispersion is achieved.

The separating device can be formed at least by one gap which is realized between the first and the second process regions.

A separating device of this type enables the transition of dispersions from the first into the second process region.

The separating device can include a first and a second gap-forming element, wherein the gap-forming elements include openings and the two gap-forming elements are moved relative to one another, wherein the openings do not overlap such that a dynamic separating gap is created.

As a result of this type of separating device, a high throughput is obtained and the risk of blockages is reduced by the exclusive presence of dynamic separating gaps.

The separating device can additionally include the following:
a first gap-forming element, in a preferred manner the rotor, which is assigned to the first process region and includes openings,
a second gap-forming element, in a preferred manner a stator, which is assigned to the second process region and corresponds with the first gap-forming element, the second gap-forming element including openings,
wherein at least one of the gap-forming elements, in a preferred manner the rotor, is realized so as to be rotatable about a rotational axis relative to the other gap-forming element.

The openings of the first gap-forming element and the openings of the second gap-forming element are arranged in such a manner that a mixture produced from the fed materials is conductible from the first into the second process region through the openings in the two gap-forming elements.

A device of this type results in high throughput without there being any risk of a blockage.

The gap-forming elements have to be rotatable relative to one another such that both elements can also be realized in a rotatable manner. In said case, the rotational speeds and/or the direction of rotation have to differ.

In a preferred manner, the openings in the gap-forming elements are arranged in such a manner that the openings do not overlap and material can only pass from the openings of the first gap-forming element to the openings of the second gap-forming element through a gap between the openings. Once the gap gas been passed, the openings are to enable a large material flow and consequently comprise an opening diameter/opening cross section that is large compared to the gap.

The gap is realized between the two gap-forming elements. The smallest dimension of the openings in the first gap-forming element is, in a preferred manner, at least 3 times as large as the largest dimension of the gap between the two gap-forming elements. In a preferred manner, the smallest dimension of the openings in the second gap-forming element is also at least 3 times as large as the largest dimension of the gap between the two gap-forming elements. For an embodiment where the second gap-forming element includes annular gaps, the dimensions of the annular gaps must obviously correspond substantially to the dimension of the gap between the gap-forming elements or must be smaller than the gap between the gap-forming elements. In an embodiment with annular gaps of a gap-forming element, a high throughput is obtained through a high number of annular gaps. The gap according to the invention between the first gap-forming element and the second gap-forming element has a separating function. The dimension of the gap prevents particles that are larger than the gap from passing into the second process region.

At least one, in a preferred manner two, in a preferred manner dynamic, gaps are formed between the housing and the first gap-forming element.

Consequently, elements that are too large are also prevented from passing between the housing and the first gap-forming element. Nevertheless, further separating devices are not necessary.

The first gap-forming element can surround the second gap-forming element and a gap of a maximum of 3 mm, in a preferred manner 1.0 mm and in particular preferred 0.5 mm, can be realized between the two elements. The minimum gap has a transverse dimension of 0.1 mm.

In particular, a gap, the maximum extension of which is smaller than the smallest element of the dispersion grinding aids which are pourable into or poured into the device, is realized between the two gap-forming elements. In a preferred manner, the gap is a maximum of half the size of the diameter of the smallest dispersion grinding aids.

Grinding tools, which are realized for mixing or dispersing the materials introduced in the first process region, can be arranged on the first gap-forming element and/or on the housing.

These types of grinding tools can be pins or discs or other known embodiments of grinding tools.

The effectiveness of the dispersing is increased because of the grinding tools. In a preferred manner, the first gap-forming element is realized as a rotor such that the movement of the fed materials and possibly of the dispersion grinding aids is generated by way of the grinding tools on the rotor and thus dispersion is achieved in the first process region. The first gap-forming element can extend in a substantially total manner along a length of the first process region.

Consequently, a large surface is provided with gaps which are not able to clog up and even so achieve a large flow rate.

Dispersion grinding aids, the forwarding of which into the second process region is preventable by means of gaps, in particular dynamic gaps, can be poured into the first process region.

The dynamic gaps can be realized between the first gap-forming and the second gap-forming elements as well as additionally between the first gap-forming element and the housing. Consequently, exclusively material that has been completely dispersed passes into the second process region and the movement at the gap edges means that the gaps cannot be blocked.

In a preferred manner, no static separating device is realized between the first and the second process regions.

Consequently, the static separating device cannot be clogged. A static separating device is a separating device where the edges of the openings, through which the mixture passes, do not move. Static separating devices are consequently, in particular, fixedly mounted sieves.

As an alternative to this, the second gap-forming element can be realized as a static separating device, the openings in the static separating device, in a preferred manner, being smaller than the minimum diameter of the dispersion grinding aids. In a particularly preferred manner, the openings in the static separating device are formed by annular gaps.

A static separating device of this type holds back dispersion grinding aids and oversize particles from the second process region.

Both gap-forming elements can be realized in a cylindrical or conical manner.

Consequently, a large surface can be obtained for the passage from the first into the second process region along with a high level of rotational energy at the same time.

As an alternative to this, it would be conceivable to realize the gap-forming elements as circular discs which are arranged between the first and the second process region.

The gap between the first gap-forming element and the second gap-forming element can comprise a longitudinal dimension which is realized parallel to the rotational axis. Where there are circular-disc-shaped gap-forming elements, the gap can be realized substantially perpendicular to the rotational axis. Where the gap-forming elements are conical, the gap can be realized at an angle of between 1° and 89° with respect to the rotational axis.

Consequently, reliable separation of the grinding aids can be achieved without clogging being possible.

The openings of the gap-forming elements can extend along a length of at least 50%, in a preferred manner 60% and particularly preferred 70% of the length of the first gap-forming element in the first process region.

Consequently, a high throughput can be achieved.

The relative specifications refer, in this connection, not to the dimension of the openings, but to the region which is provided with openings.

In addition, two or more bores can be connected together at the periphery of the second gap-forming element by a groove, in a preferred manner a milled groove. The groove must obviously not overlap with the openings in the first gap-forming element. Consequently, a large outflow volume can be created and the mixture is quickly discharged into the second process region.

The housing of the device can additionally include a pump housing or can be connected to a pump housing which realizes a pump on the housing of the device. The pump housing and the housing of the device can be realized in one piece or in multiple pieces. In the case of multiple-piece realization, in a preferred manner the pump housing is flange-mounted on the housing of the device.

A pump is arranged in the pump housing.

Consequently, the required pump is directly connected to the device for mixing and only a control means as well as a few external lines are necessary.

The same shaft as for driving the moving gap-forming element and/or the grinding tool is used to drive the pump.

This results in fewer individual parts and, as a result, in less complexity.

The pump housing includes a pump inlet and a pump outlet.

The pump can be a centrifugal pump, a liquid ring pump, a side-channel pump or a displacement pump, such as, for example an impeller pump.

The mixture can be conducted additionally by one or several dynamic gaps between the first gap-forming element and a housing of the device.

Consequently, a dynamic separating device, which does not clog up and at the same time simplifies the design of the device, is provided between the housing and the device.

The dispersing in the first process region can be achieved by dispersion grinding aids and/or grinding tools.

Grinding tools can be discs or pins or similar grinding tools which are already known from the prior art. Dispersion grinding aids are hard, round or elliptical bodies which contribute to the dispersing of the material. The dispersion grinding tools are held by the gap/the gaps between the gap-forming elements and/or the housing.

The dispersing can be achieved by dispersion grinding aids which comprise a diameter which is at least 1.5 times, in a preferred manner 3 times and particularly 10 times larger than the largest gap as the transverse dimension.

Consequently, the dispersion grinding aids cannot pass through the gap and the gap serves as a dynamic separating device.

The mixture can be conducted through at least 4, in a preferred manner 20 and particularly preferred 100, openings in the first gap-forming element. The mixture can additionally be conducted through at least 4, in a preferred manner 50 and particularly preferred a minimum of 200, openings in the second gap-forming element. Consequently, an optimized throughput of mixture can be achieved by means of the number of openings. The openings in the second gap-forming element can be formed at least in part by bores.

In addition, two or more bores can be connected together on the periphery by a groove, in a preferred manner a milled groove. Obviously, the groove must not overlap with the openings in the first gap-forming element. Consequently, a large outflow volume can be created and the mixture is rapidly discharged into the second process region.

The invention is explained in more detail in exemplary embodiments below by way of figures, in which:

FIG. 1 shows a section through a device according to the invention,

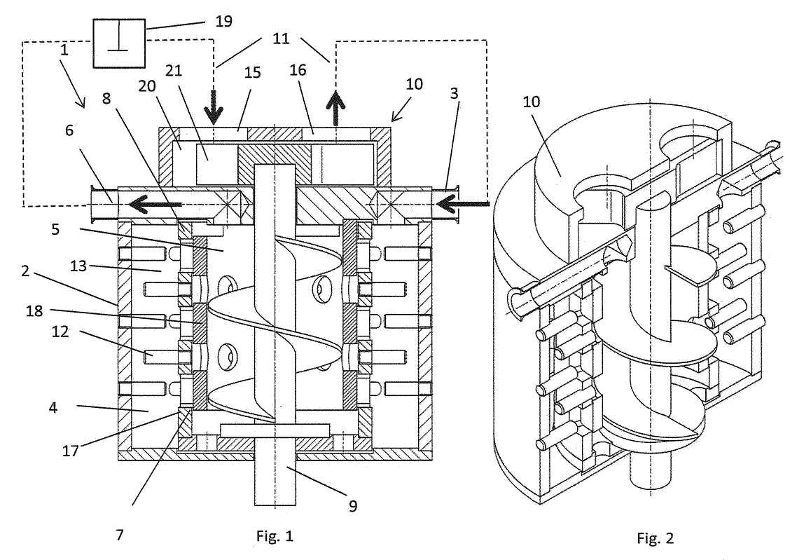

FIG. 2 shows a view of the section through a device according to FIG. 1,

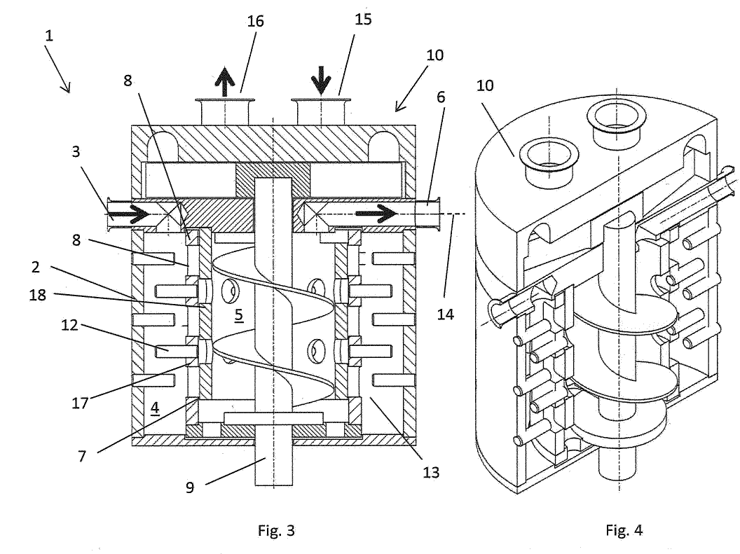

FIG. 3 shows a section through an alternative embodiment of the device according to the invention,

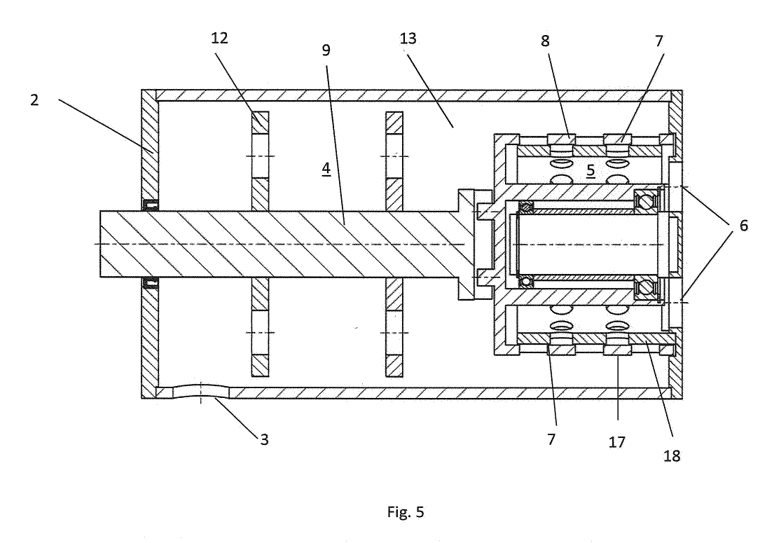

FIG. 4 shows a view of the section through a device according to FIG. 3,

FIG. 5 shows a section through a further alternative embodiment of the device according to the invention.

FIGS. 1 and 2 show a section through a device 1 according to the invention. The device 1 includes a housing 2. Materials to be mixed can be introduced into the grinding chamber 13 through an inlet 3. The grinding chamber 13 includes a first process region 4 and a second process region 5. The first process region 4 has a dispersion volume of substantially 6 litres. Grinding tools 12, which are set in rotation by a drive shaft 9, are arranged on a rotor 8 in the first process region. In addition, static grinding tools are realized in the first process region 4. A separating device 7, which consists of a first 17 and a second gap-forming element 18, is realized between the first process region 4 and the second process region 5. A separating gap, which in particular when dispersion grinding aids are used in the first process region 4 achieves separation of the dispersion grinding aids prior to the transfer of the mixture into the second process region 5, is realized between the two gap-forming elements 17, 18. The mixture is conducted through the outlet 6 out of the grinding chamber 13 out of the second process region 5. A recirculation line 11, by means of which the mixture is conducted out of the second process region 5 through the outlet 6 back via the pump 10 into the inlet 3, is realized in the embodiment according to FIG. 1. The recirculation line includes a recirculation container 19 with an agitator tool. Consequently, optimum reduction of the oversize material can be achieved. Obviously, the mixture or part of the mixture can also be conducted at times or constantly through a line (not shown) into a fine dispersion stage. The pump 10 comprises a pump chamber 20 and a pump rotor 21. The pump rotor 21 is arranged on the drive shaft 9.

The pump 10, in this case, is a water ring pump. The materials or the pre-mixture are introduced through the pump inlet 15 into the pump 10 and are pumped out of the pump outlet 16 into the inlet 3 of the device 1. The embodiment shown does not have any dispersion grinding aids. However, it is obviously possible to pour these in, if this is wanted. When using dispersion grinding aids, they comprise a mean diameter of between 1.5 mm and 5.0 mm, in a preferred manner of 3.00 mm. The first process region 4 extends substantially along the first gap-forming element 17. Consequently, a high throughput can be achieved.

FIGS. 3 and 4 show an alternative embodiment analogous to FIGS. 1 and 2. The device 1 includes a housing 2 with an inlet 3. Materials to be mixed can be introduced into the grinding chamber 13 through the inlet 3. The grinding chamber 13 includes a first process region 4 and a second process region 5. The first process region 4 has a dispersion volume of substantially 6 litres. Grinding tools 12, which are set in rotation by a drive shaft 9, are arranged on a rotor 8 in the first process region. In addition, static grinding tools are realized in the first process region 4. A separating device 7, which consists of a first 17 and a second gap-forming element 18, is realized between the first process region 4 and the second process region 5. A separating gap, which in particular when dispersion grinding aids are used in the first process region 4 achieves separation of the dispersion grinding aids prior to the transfer of the mixture into the second process region 5, is realized between the two gap-forming elements 17, 18. The mixture is conducted out of the second process region 5 through the outlet 6 out of the grinding chamber 13. In place of a water ring pump as shown in FIGS. 1 and 2, in said embodiment a side-channel pump is realized as pump 10. The materials or the pre-mixture are introduced through the pump inlet 15 into the pump 10 and are pumped out of the pump outlet 16 into the inlet 3 of the device 1. The dispersed mixture is conducted through the outlet 6 by means of a line 14 to a fine dispersion stage. Obviously, the embodiment according to FIG. 3 can also be provided with a recirculation line with a recirculation container 19 with an agitator (not shown) analogously to FIG. 1. In addition, it is possible to recirculate part of the mixture and to conduct part of the mixture via line 14 into the fine dispersion stage and/or to carry out recirculation at times and only then to forward the mixture through line 14 to a fine dispersion stage.

FIG. 5 shows an alternative embodiment of the device 1 in which the separating device 7 and the gap-forming elements 17, 18 only extend over a part region of the first process region 4. In addition, grinding tools 12 in the form of discs with holes are realized in the first process region 4. The first gap-forming element 17 is the rotor 8 which rotates about the second gap-forming element 18. Both gap-forming elements 17, 18 in each case comprise openings. The mixture flows from the first process region 4 through the separating device 7 in the form of separating gaps into the second process region 5. In addition, the housing 2 comprises an inlet 3 and an outlet 6. The grinding tools 12 are arranged on a drive shaft 9. The drive shaft 9 includes a shaft groove into which engagement cams of the first gap-forming element engage. Consequently, the first gap-forming element 17 is driven by the same shaft as the grinding tools. The grinding chamber 13 includes the first process region 4 and the second process region 5. The first process region 4 has a dispersion volume of substantially 6 litres.

1-15. (canceled)

16. A device for mixing, said device including:
a housing with at least one inlet,
a grinding chamber,
a first process region for mixing fed materials, wherein the materials are introducible into the first process region through the at least one inlet,
a second process region for diverting the mixture to an outlet,
a separating device for separating the first process region from the second process region,
a rotor for mixing, in particular dispersing the mixture in the first process region, and the rotor is drivable by a drive shaft,
a pump connected upstream is drivable by the drive shaft and materials are feedable by the pump into the first process region and the first process region comprises a dispersion volume within the range of 1 l-50 l, and
the pump comprises a pump chamber with an outlet, which is in fluid communication with an inlet of the first process region.

17. The device according to claim 16, wherein the rotor is designed for dispersing the mixture in the first process region.

18. The device according to claim 16, wherein the separating device is at least one separating gap.

19. The device according to claim 18, wherein the separating gap is a dynamic separating gap.

20. The device according to claim 18, wherein the separating gap has a dimension of between 0.5 mm and 3 mm.

21. The device according to one claim 16, wherein a recirculation container and/or a recirculation line is arranged between the outlet and the inlet.

22. The device according to one claim 21, wherein the device comprises a recirculation container with an agitating tool.

23. The device according to one claim 16, wherein dispersion grinding aids are pourable or poured into the first process region.

24. The device according to claim 23, wherein dispersion grinding aids have a mean diameter of between 1.5 mm and 5.0 mm.

25. The device according to claim 16, wherein grinding tools, which are realized for generating dynamic movement in the mixture for dispersing the fed materials, are realized in the first process region.

26. The device according to claim 16, wherein a ratio of a main line diameter in front of the inlet and dispersion volumes is within a range of between 8 and 16 mm/l.

27. The device according to claim 16, wherein the outlet is connectable or connected to an inlet of a fine grinding stage.
